(19) United States
(12) Patent Application Publication
(10) Pub. No.: US 2016/0082685 A1
(43) Pub. Date: Mar. 24, 2016

(54) APPARATUS, SYSTEMS AND METHODS FOR CONFIGURING/ FEEDING SHEET STOCK MATERIAL FOR A DUNNAGE SYSTEM AND FOR GENERATING UPRIGHT EDGE DUNNAGE STRIPS

(71) Applicant: Simon CS Chan, Seattle, WA (US)

(72) Inventor: Simon CS Chan, Hong Kong (HK)

(21) Appl. No.: 14/859,250

(22) Filed: Sep. 18, 2015

Related U.S. Application Data
(60) Provisional application No. 62/053,041, filed on Sep. 19, 2014.

(51) Int. Cl. B31D 5/00

(52) U.S. Cl. CPC B31D 5/0043

(57) ABSTRACT

Various embodiments for stock material for dunnage systems are provided with multi-directional perforation lines, including laterally and longitudinally extending perforations. The stock material can be configured in fan-fold or rolled form, and can be pre-folded. The perforations can help weaken the configured stock material to conform to holding trays. The holding trays can hold horizontally aligned fan-fold stacks of the stock material. Also, the configured stock material can be fed to a dunnage system have forming members that rotate about a vertical axis to generate cushioning strips with a vertical width greater than a horizontal width. Various methods and systems are also provided for making and using the same.

### BACKGROUND

1. Technical Field

The present disclosure relates generally to stock material configuration for dunnage systems, and methods for converting stock material into cushioning material and/or void fill material in a dunnage system.

2. Description of Related Art

Dunnage machines, or dunnage systems, are used to produce cushioning material. The dunnage machines typically receive feed from a stock material, such as paper, provided in a paper roll. One such example prior art dunnage system is disclosed in U.S. Pat. No. 8,501,302 (entitled “Off-set Gears and Methods of Using Off-Set Gears for Producing Cushioning Material”). The paper roll can be mounted on a holder that permits the roll to unwind and dispense paper, or other stock material. Alternatively, the stock material can be provided in fan-fold form (e.g., a fan-fold stack), wherein paper is pulled from a fan-fold stack of the stock material to feed a dunnage machine. Some prior art paper dunnage systems, such as that shown in FIGS. 1a-1b, can also have a holding tray, the holding tray 1′ being used to hold the stock material in a fan-folded stack 12. For example, referring to the fan-fold stack 12 in FIG. 1b (assuming, for example, that the stock material 10 is paper), each layer 10″ of a continuous paper 10 in the fan-fold stack 12, is folded over a successive layer 10″, about a lateral crease 10′, in alternating fashion, in a longitudinal direction. In stacked form then, the creases 10′ are disposed on alternating front/back sides of the fanfold stack 12 (the front side, then the back side, and so on and so forth).

Referring to prior art FIG. 1a, from the holding tray, the stock material is fed to an inlet section, or inlet port 1″, of the dunnage system 1, then through forming members (e.g., gears or paddles) driven by a motor, to volumize the stock material, which can then be used, for example, to fill voids and/or providing padding in a packaging box, carton or other container.

Currently, the most commonly used paper widths for stock material are about 15 inches wide for void fill dunnage systems and about 30 inches wide for cushioning dunnage systems. A difference between void fill dunnage systems and cushioning dunnage systems is typically that void fill dunnage is often produced to occupy higher volume, with lower overall density, to fill voids. Cushioning dunnage systems can typically provide padding for protection against, for example, dropping damage, whereas void fill dunnage systems can typically provide a void filling material that is used to help prevent shifting of products in containers.

Generally, stock material (e.g., paper) feed source for a dunnage system having a wider, rather than narrower, width is preferred because wider material width provides a higher rate of material feed to the dunnage systems, which in turn, results in higher dunnage output/product rate. However, the wider the stock material, the larger a foot print that is occupied by the dunnage system overall. In packaging facilities, a large foot print is undesirable because, among other things, a large foot print increase dunnage system size and weight, and also, factory space can be at a premium and because users/workers can be more efficient and safer when using more compact and lighter machines.

U.S. Pat. No. 6,015,374 discloses the use of fan-folded stock material for a cushioning conversion machine, and further provides that the stock material can comprise laterally extending fold lines about which sections of the stock material have been folded in a longitudinal direction to create the fan-folded stack of material. In additional, laterally inwardly folded longitudinal sections are created before forming the fan-fold stack to decrease the width of the fan-folded stack, while still permitting the stack to be fed to a dunnage machine.

FIGS. 10a-10c show a prior art dunnage system 2b having a feed system that utilizes fan-fold stacks 26a, 26b of stock material. FIG. 10a illustrates a new or “fresh” fan-fold stack 26a having an adhesive or tape 26a″ on a beginning (top) section, used in a method of replenishing stock material 26. A finishing end section 26b′ of an almost depleted supply of stock material 26b, is connected to a beginning section 26a′ of a new or fresh supply of stock material 26a, by taping or otherwise adhering, the beginning section of the new supply to the finishing end section of the almost depleted supply. This helps prevent the necessity to re-prime the dunnage machine, or re-connect the front end section of a stock material supply to the dunnage machine, which can be time consuming. Instead, by joining the stock material supply together (e.g., fan-fold stacks, or paper rolls), re-priming of the dunnage machine can be avoided because the almost depleted supply will pull the new supply into primed configuration as if the depleted supply had not be depleted at all.

Referring to FIG. 10a (prior art), an almost depleted fan-fold stack 26b is lifted in a tray 4, so that a fresh fan-fold stack 26a can be placed beneath it. Also, the fresh fan-fold stack 26a has a beginning section edge that is lined with an adhesive 26a″. As shown in FIG. 10c (prior art), the edge of the beginning section or finishing section is lined with an adhesive strip 26a″, which can be covered with a peel-away liner strip 27 when delivered to a user, to preserve the adhesive qualities of the adhesive until it is ready for use. Before the fresh fan-fold stack 26a is placed on the tray 4, the liner 27 is peeled away from the adhesive 26a″ to expose it. Thereafter, once the new fan-fold stack 26a is placed on the tray 4, the beginning edge having the adhesive 26a″, can be attached to a bottom or finishing end section of the almost depleted fan-fold stack 26b. Once the almost depleted stack 26b is depleted, the new stack 26a will be pulled into a feed of the dunnage system.

### BRIEF SUMMARY

In some embodiments, a continuous stock material is provided in a roll or a fan-fold stack configuration for use in feeding a dunnage machine, the stock material having at least one longitudinal perforation line. The longitudinal perforation line can extend continuously throughout an entire length of the continuous stock material in the roll or fan-fold stack. The continuous stock material can also have at least a second longitudinal perforation line and can comprise a plurality of lateral perforation lines. Moreover, the continuous stock material can have at least one laterally centrally disposed longitudinal perforation line, and one longitudinal perforation line disposed parallel to the centrally disposed longitudinal perforation line on each side of the centrally disposed longitudinal perforation line.

In some embodiments, a dunnage system comprises a housing having a feed port and an output port; a forming member contained within the housing; a motor for driving the forming member; and a stock material feed tray having a holding surface with varying slope.

In some embodiments, a dunnage system comprises a housing containing a forming member; a motor for driving the forming member; and a stock material loading tray, the loading tray having a planar holding surface configured to retain multiple stacks of fan folded stock material placed horizontally on the holding surface. Also, the dunnage system can further comprise a first fan-fold stack of stock material and a second fan-fold stack of stock material, with both fan-fold stacks of stock material retained in horizontal orientation on the loading tray and with the first fan-fold stack of stock material attached by a finishing section thereof to a beginning section of the second fan-fold stack of stock material. Also, the housing has an output port disposed on a front portion of the housing, and the loading tray can be disposed below the housing and extend forward from the front portion of the housing by at least 8 inches during operation of the dunnage system. Moreover, the loading tray can comprise an end plate imparted with a lateral angle.

In some embodiments, a dunnage system comprises a housing containing one or more forming members, and a motor connected to the forming members, wherein the housing is resting on a horizontal surface and is oriented to dispense cushioning material in a continuous dunnage strip having a vertical width that is greater than a horizontal width. In some embodiments, the dunnage system the dispensed dunnage strip has a maximum width that is substantially vertically oriented. Also, the forming members can be oriented to rotate about a vertical axis.

### BRIEF DESCRIPTION OF THE DRAWINGS

FIG. 1a is a perspective view of a prior art dunnage system with a fan-fold stack of stock material as a feed source.

FIG. 1b is a perspective view of a prior art fan-fold stack of paper stock material.

FIG. 2a is a front elevation of an embodiment of a dunnage system of the present disclosure having a u-shape holding tray, holding a fan-fold stack of stock material.

FIG. 2b is a perspective view of the dunnage system of FIG. 2a, with the fan-fold stack of stock material removed.

FIG. 2c is a perspective view of the dunnage system of FIG. 2a.

FIG. 3a is a front elevation of an embodiment of a dunnage system of the present disclosure having a saddle-shape holding tray, holding a fan-fold stack of stock material.

FIG. 3b is a perspective view of the dunnage system of FIG. 3a, with the fan-fold stack of stock material removed.

FIG. 3c is a perspective view of the dunnage system of FIG. 3a.

FIG. 4a is an overhead plan view of a section of perforated stock material, such as paper, having longitudinal and lateral perforation lines, in accordance with some embodiments of the present disclosure.

FIG. 4b is an overhead plan view of the stock material of FIG. 4a, having outside longitudinally extending sections folded laterally inward to overlap a middle longitudinally extending section, to generate a pre-configured stock material.

FIG. 4c is a perspective view showing the perforated stock material of FIG. 4b, configured in a fan-fold stack.

FIG. 5 is a perspective view a showing a perforated stock material having a longitudinally extending perforation line, configured in a fan-fold stack, in accordance with some embodiments of the present disclosure.

FIG. 6a is a front elevation of an embodiment of a dunnage system of the present disclosure having a v-shape holding tray, holding a fan-fold stack of stock material.

FIG. 6b is an overhead plan view of the dunnage system of FIG. 6a.

FIG. 6c is a perspective view of the dunnage system of FIG. 6a, with the fan-fold stack of stock material removed.

FIG. 7a is a front elevation of an embodiment of a dunnage system of the present disclosure having an inverted v-shape holding tray, holding a fan-fold stack of stock material.

FIG. 7b is a perspective view of the dunnage system of FIG. 7a, with the fan-fold stack of stock material removed.

FIG. 8 is a perspective view a showing a perforated stock material having two longitudinally extending perforation lines, configured in a fan-fold stack, in accordance with some embodiments of the present disclosure.

FIG. 9a is a front elevation of an embodiment of a dunnage system of the present disclosure having a holding tray comprised of multiple planar sections with alternating slopes.

FIG. 9b is a perspective view of the dunnage system of FIG. 9a, with the fan-fold stack of stock material removed.

FIG. 10 is a perspective view a showing a perforated stock material having three longitudinally extending perforation lines, configured in a fan-fold stack, in accordance with some embodiments of the present disclosure.

FIGS. 10a-10c show a prior art dunnage system, including a detail view of an edge of a finishing section, or edge of a beginning section of fan-fold stack of stock material, such as paper stock material, having an adhesive section, covered by a removable liner.

FIG. 11a is a perspective view of a dunnage system for some embodiments of the present disclosure, comprising a loading tray and horizontally disposed fan-fold stacks of stock material retained in the feed tray.

FIG. 11b, is a simplified overhead plan view illustrating fan-fold stacks of stock material disposed horizontally on a horizontal feed tray, in accordance with some embodiments of the present disclosure.

FIG. 11c is a perspective view of the dunnage system in FIG. 11a, further showing a work station, or table top, retained above the loading tray, and further showing a work piece (e.g., container) placed on the table top, for some embodiments of the present disclosure.

FIG. 11d is an overhead plan view of the dunnage system of FIG. 11c, with the table top.

FIG. 11e is a side elevation view of the dunnage system of FIG. 11c, with the table top.

FIG. 11f is an alternate perspective view of the dunnage system of FIG. 11a, with the fan-fold stacks having been removed to further reveal a configuration of the loading tray and end plates thereof, for some embodiments of the present disclosure.

FIG. 11g is an alternate perspective view of the dunnage system of FIG. 11a, with the fan-fold stacks compressed together, and connected together, such as by one or more adhesive strip sections provided on the fan-fold stacks.

FIG. 12 is a perspective view of a dunnage system for some embodiments of the present disclosure, having a pre-configured stock material feed source configured in a fan-fold stack, with a housing of the dunnage systems disposed at 90 degrees from a conventional orientation such that its forming members rotate about a vertically disposed axis.

FIG. 12b is a perspective view of the dunnage system of FIG. 12, further showing a dunnage strip dispensed from an output of the housing, with an end portion of the dunnage strip having been wound horizontally.

FIG. 12c shows perspective views of containers in which horizontally wound sections of dunnage strip, formed via the dunnage system of FIG. 12b, have been placed in the containers a) at a bottom of the container so that a product to be packaged can be placed on top of the wound dunnage strip, b) around a product in the container, and c) above a product in the container, respectively.

### DETAILED DESCRIPTION

In the following description, certain specific details are set forth in order to provide a thorough understanding of various embodiments of the disclosure. However, upon reviewing this disclosure one skilled in the art will understand that the disclosure may be practiced without many of these details. In other instances, well-known or widely available machine parts, dunnage control systems, or stock materials used in creating cushioning or void fill material have not been described in detail to avoid unnecessarily obscuring the descriptions of the embodiments of the present disclosure.

In the present description, inasmuch as the terms “about,” “substantially,” “approximately,” and “consisting essentially of” are used, they mean±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, both of which are intended to be construed in a non-limiting sense, as are variants thereof, unless otherwise expressly stated.

Various embodiments of the present disclosure are described for purposes of illustration, in the context of use with paper-based sheet stock materials for dunnage formation. However, as those skilled in the art will appreciate upon reviewing this disclosure, other materials may also be suitable. Throughout this disclosure, unless otherwise indicated, the term “sheet” can also refer to multi-ply material, with each “sheet” having multiple layers comprising thinner sheets.

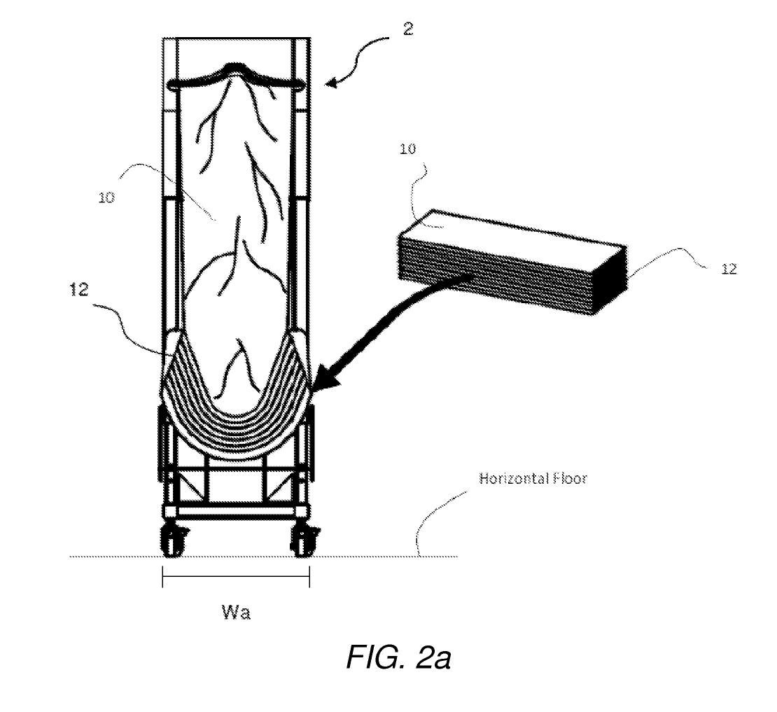

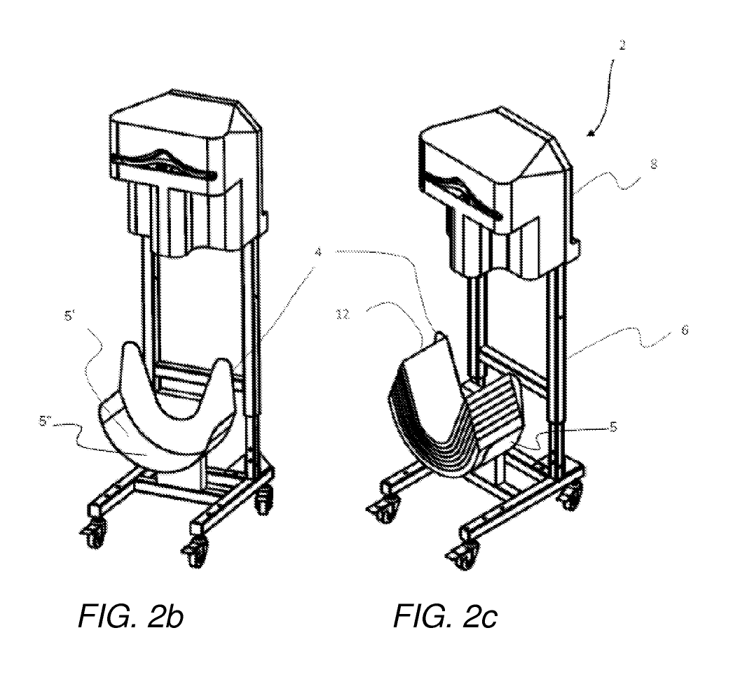

FIGS. 2a-2c show an embodiment of a dunnage machine 2 of the present disclosure having a feed system for feeding stock material 10 (e.g., paper, or multi-ply paper) to the dunnage machine. The feed system can include a holding tray 4 for holding a fan-fold stack 12 of the stock material 10. The tray 4 of the present disclosure, as illustrated in FIGS. 2a-2c, has a non-planar holding element 5. The holding element 5 can have a holding surface 5′, and the holding surface 5′ can be, for example, a curved “U-shape,” or partial U-shape, holding surface, with at least a portion of the holding surface 5′ sloping inwardly downward from opposing lateral sides of the holding element 5, with a slope (e.g., measured relative to a tangent line at any single point of the holding surface) of the holding surface 5′ gradually decreasing in approaching a lateral center 5″ of the tray 4.

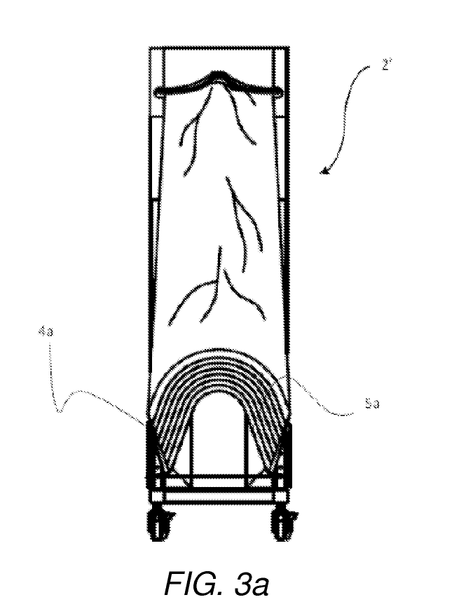

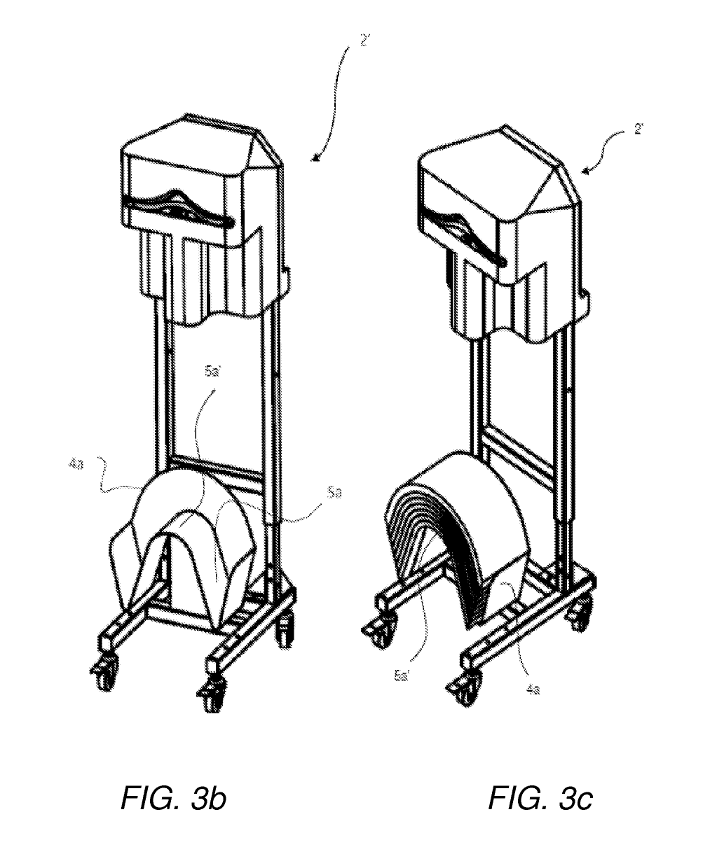

In other embodiments, such as shown in FIGS. 3a-3c, a holding surface 5a of the tray 4a can be a saddle-shape, or partial saddle-shape, with at least a portion of the holding surface 5a sloping inwardly upward approaching from opposing lateral sides of the holding surface 5a, with the slope of the holding surface 5a gradually decreasing in approaching a lateral center 5a′ of the tray 4a. In the tray embodiments 4, 4a, disclosed in FIGS. 2a-3c, the lateral center 5″, 5a′ of the holding surfaces 5, 5a can be the lowest point, and highest point, respectively, on the holding surfaces.

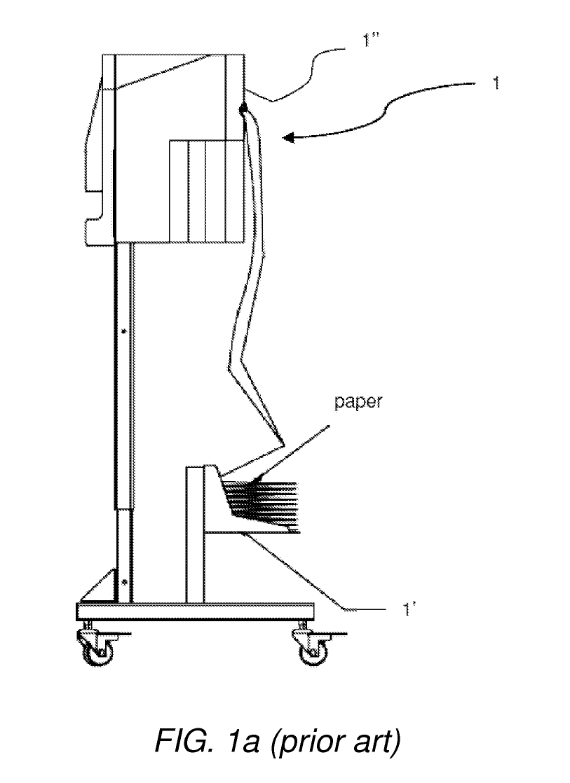

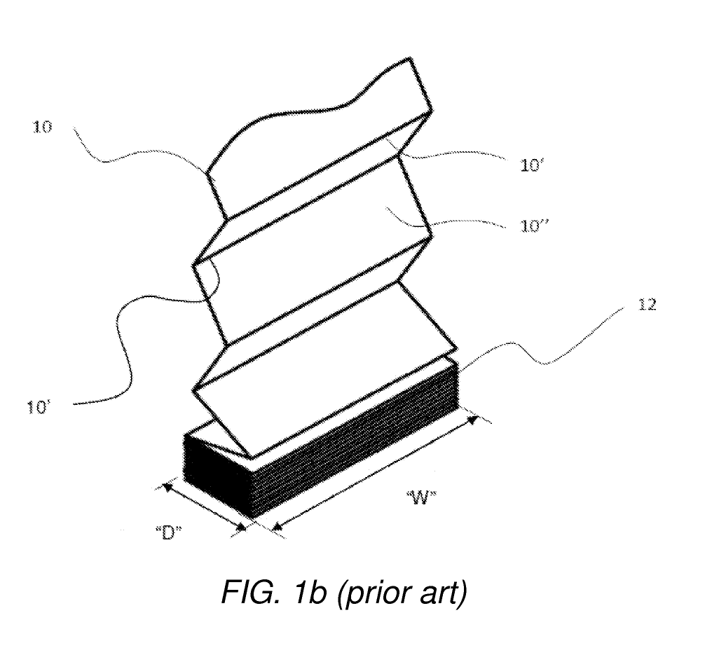

In the embodiments shown in FIGS. 2a-3c, the fan-fold stack 12 of stock material 10 can be placed in the trays 4, 4a and can conform to the contour of the holding surfaces 5′, 5a under its own weight. That is, for example, when the fan-fold stack 12 is placed on the holding surfaces 5′, 5a, the weight of the successive layers 10″ (or each “flap”) of paper 10, can cause the stack 12 to conform to the shape of the holding surfaces 5′, 5a, and as such, a width of the stack can be reduced. In particular, for example, referring also to FIG. 1b, if the fan-fold stack 12 has original flat width (“W”) of 30 inches, and depth (“D”) of 10 inches, a resulting foot print of the fan-fold stack 12 imposed relative to a horizontal floor (See, e.g., FIG. 2a) upon which the dunnage machine 2, 2′ rests, can be 10 inches deep with a reduced width of “Wa,” due to conformance with the tray 4. In some embodiments, the tray 4, 4a has a width “Wa” of 21 inches. In some embodiments, the width can be more or less than 21 inches, depending on the contours of the holding surfaces 5′, 5a, which can be constructed using different contours and/or slopes other than those illustrated (e.g., steeper or more shallow), which can be selectively chosen, to decrease or increase the width of the footprint of the holding tray 4, 4a, as will be appreciated by those skilled in the art after reviewing the present disclosure.

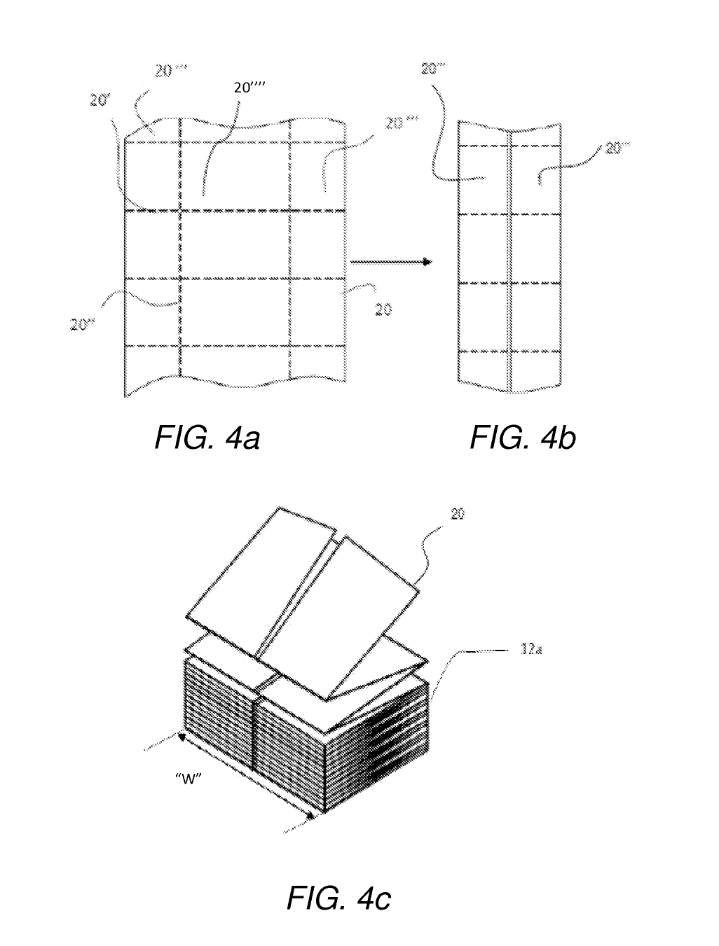

Referring to FIG. 4a-4c, in some embodiments of the present disclosure, a fan-fold stack 12a is formed from perforated stock material, or perforated paper 20. In some embodiments, the perforations, represented by dashed lines in FIG. 4a, can extend entirely through multiple layers of material if the sheets are multi-ply, or partially through the sheets. In some embodiments, the perforations may have different shapes, such as, for example, circular perforations, or slots. As best seen in FIG. 4a, in some embodiments, lateral perforation lines 20′ (comprised of a plurality of aligned perforations) and longitudinal perforation lines 20″, can be provided in spaced apart fashion throughout the stock material folded in a fan-fold stack (or wound in a roll), which can be a continuous sheet of perforated paper 20 (from the beginning of the stack to the end of the stack, or from the beginning of a roll of stock material to the end of the roll) as will be appreciated by those skilled in the art after reviewing this disclosure.

Referring to FIG. 4b, in some embodiments, laterally separated longitudinally extending sections 20′″ (or otherwise referred to herein as a longitudinal section) of the stock material 20 can be folded laterally inward about the longitudinal perforation lines 20″. In particular, for example, outside longitudinally extending sections 20′″, separated by a middle longitudinally extending section 20″″, of the stock material 20 can be folded inward to overlap the middle longitudinally extending section 20″″, about the longitudinal perforation lines 20″.

Referring to FIG. 4c, in some embodiments of the present disclosure, the pre-configured stock material 20 of FIG. 4b, can be used to generate pre-configured fan-fold stack 12a of stock material, which can be used for feed to a dunnage system for generating dunnage, or cushioning/void-fill materials.

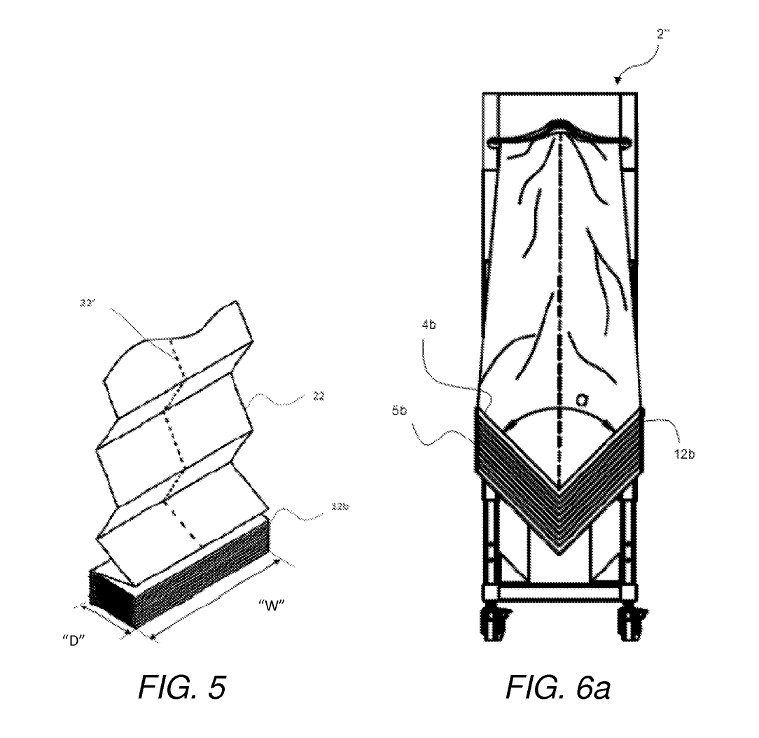

Referring to FIG. 5, in some embodiments of the present disclosure, a single longitudinal perforation line 22′ can be provided on a stock material 22, in a fan-fold stack 12b. The longitudinal perforation line 22′ can run the entire continuous length of the stock material 22 in the fan-fold stack 12b, and can assist in lateral bending (bending that can result in opposite lateral parts of the fanfold stack 12b being brought closer together or into an overlapping configuration) of the fan-fold stack 12b, to facilitate the stack's 12b conformance to the shape of a holding surface that is not planar, such as, for example, the holding surfaces 5′, 5a describe above. In some embodiments, the single longitudinal perforation line 22′ is disposed at about midway between the lateral edges of the stock material 22. In some embodiments, a laterally centered longitudinal perforation line running the entire continuous length of a sheet of stock material within a fan-fold stack or roll can also be provided for a pre-configured stock material. That is, for example, an additional longitudinal perforation line could be provided on at the lateral center of fan-fold stack 12a.

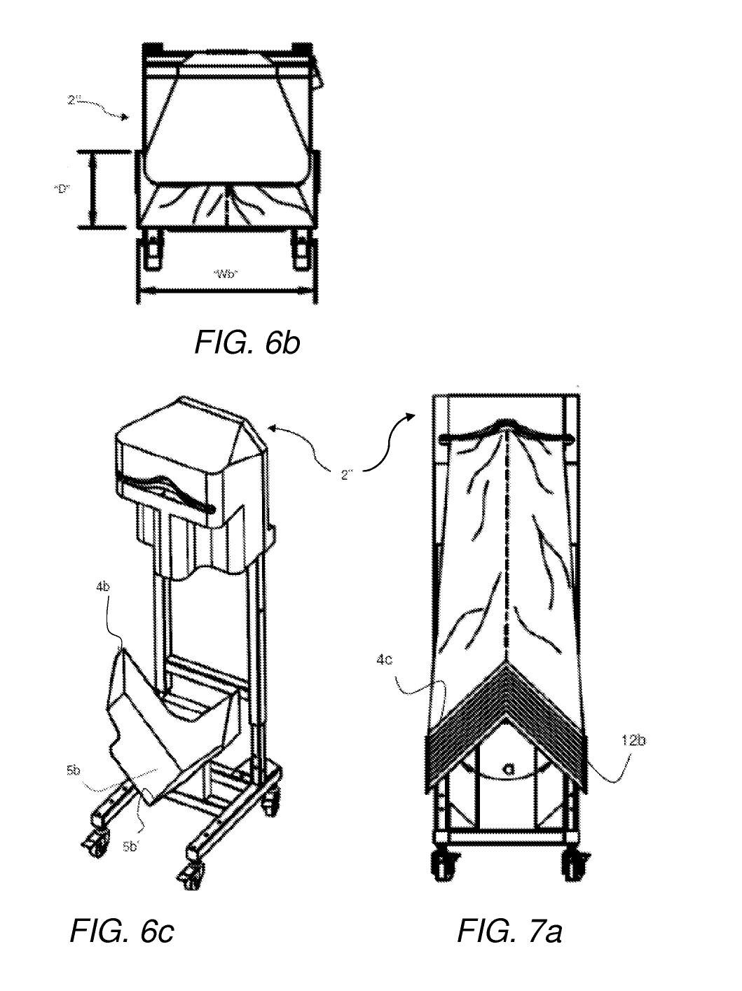

Referring to FIGS. 6a-6c, in some embodiments of the present disclosure, a holding tray 4b for a dunnage system 2″ can have a holding surface 5b, which comprises a “V-shape” surface contour, wherein at least a portion of each opposing lateral side of the holding surface 5b slopes inwardly downward in linear fashion to join at about a lateral centerline 5b′ of the holding surface 5b. Thus, for example, a standard 30 inch width stock material 22 having a single central longitudinal perforation line 22′ (See, e.g., FIG. 5), could be placed on the holding surface 5b, with the perforation line 22′ substantially aligned with a lateral centerline 5b′ (or lowest upward facing surface region) on the V-shape holding surface 5b, such that the weight of the stock material 22, combined with the weakened strength of the stock material 22 along the longitudinal perforation line 22′, can cause the fan-fold stack of material 12b to easily collapse or slump downward at the perforation line 22′ toward lateral centerline 5b′ on the holding surface 5b, thereby conforming the shape of the fan-fold stack 12b to the shape of the holding surface 5b. As a result, the tray 4b foot print width “Wb” can be, for example, less than a standard stock material width of 30 inches, but instead, can be about 26 inches, or 21 inches, or less, sufficient to retain the collapsed fan-fold stack of material 12b.

Referring to FIG. 6a, in various embodiments, depending on an angle (“a”) as measured between opposing lateral side portions (e.g., sidewalls of the “V”) of the holding surface 5b, which is also translated to top facing surfaces of the opposing lateral sides of the fan-fold stack 12b, the foot print width (“Wb”) of the tray 4b can be sized differently to accommodate the fan-fold stack 12b. For example, a tray 4b having a holding surface 5b sized to accommodate a standard 30 inch with stock material, can have the following widths “Wb” dependent on the angle “a” with which the holding surface 5b is formed:

| Angel | Approximate Footprint Width |
|---|---|
| a = 120 degrees | W = 26 inches |
| a = 105 degrees | W = 24 inches |
| a = 90 degrees | W = 21 inches |

In some embodiments, the foot print width (“Wb”) approximates the foot print width of fan-fold stack 12b on the non-planar holding surface.

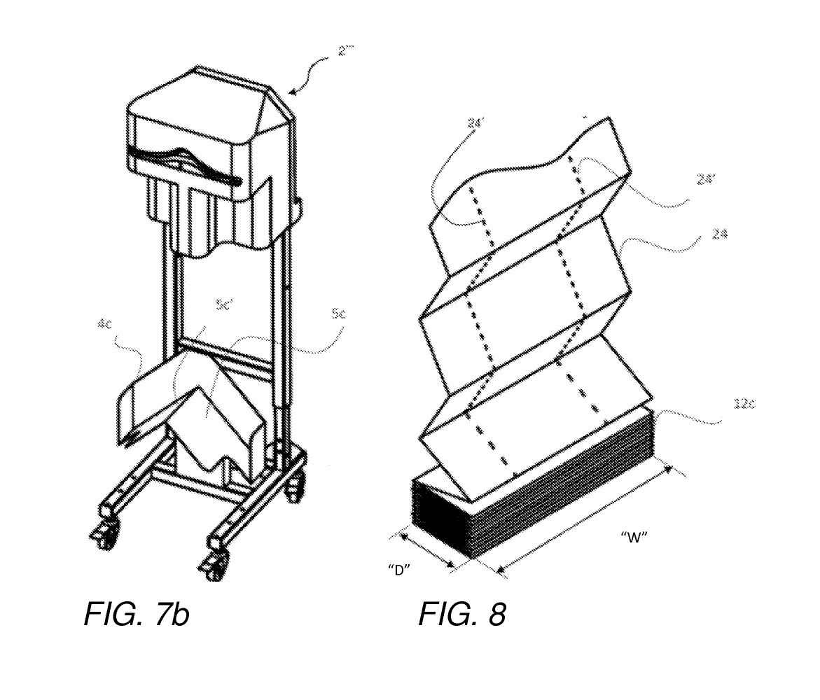

Referring to FIGS. 7a & 7b, the holding surface 5c of the tray 4c, can have a cross sectional contour that is an inverted V shape, with the centerline of the inverted V-shape contour being a ridge 5c′. The fan-fold stack 12b can be placed on the holding surface 5c, with the central longitudinal perforation line 22′ aligned with the ridge 5c′. The side portions of the fan-fold stack 12b may then collapse or slump downward about the inverted V-shaped surface, aided by the weakened central perforation line 22′. That is, opposing lateral sections of the fan-fold stack 12b can collapse downward on both sides of the ridge of the inverted V-shaped holding surface. Also, similar to that described above for holding surface 5b, in various embodiments, depending on an angle (“a”) as measured between opposing lateral sides of the holding surface 5c as shown in FIG. 7a, the foot print width of the tray 4c can be sized differently to accommodate the fan-fold stack 12b.

Referring to FIG. 8, in some embodiments of the present disclosure, multiple longitudinal perforation lines 24′ are provided on perforated paper stock material 24, which can be folded into a fan-fold stack 12c. In some embodiments, the multiple perforated lines 24′ are equally spaced apart, and/or equally spaced from lateral edges of the stock material 24. Furthermore, in some embodiments, the longitudinal perforation lines 24′ partition the stock material 24 into three longitudinal sections of equal, or approximately equal widths. In some embodiments, the perforated paper stock material of the fan-fold stack 12c also comprises lateral perforation lines, similar to lateral perforation lines 20′ shown in FIG. 4a, about which creases in the fan-fold stack 12c can be formed, or otherwise aligned.

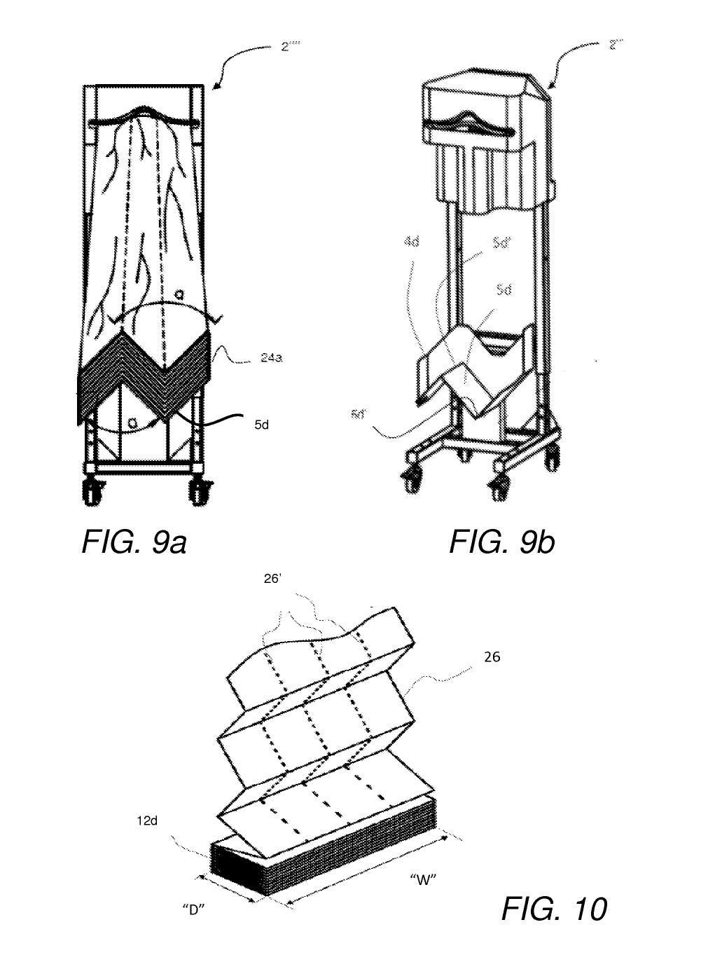

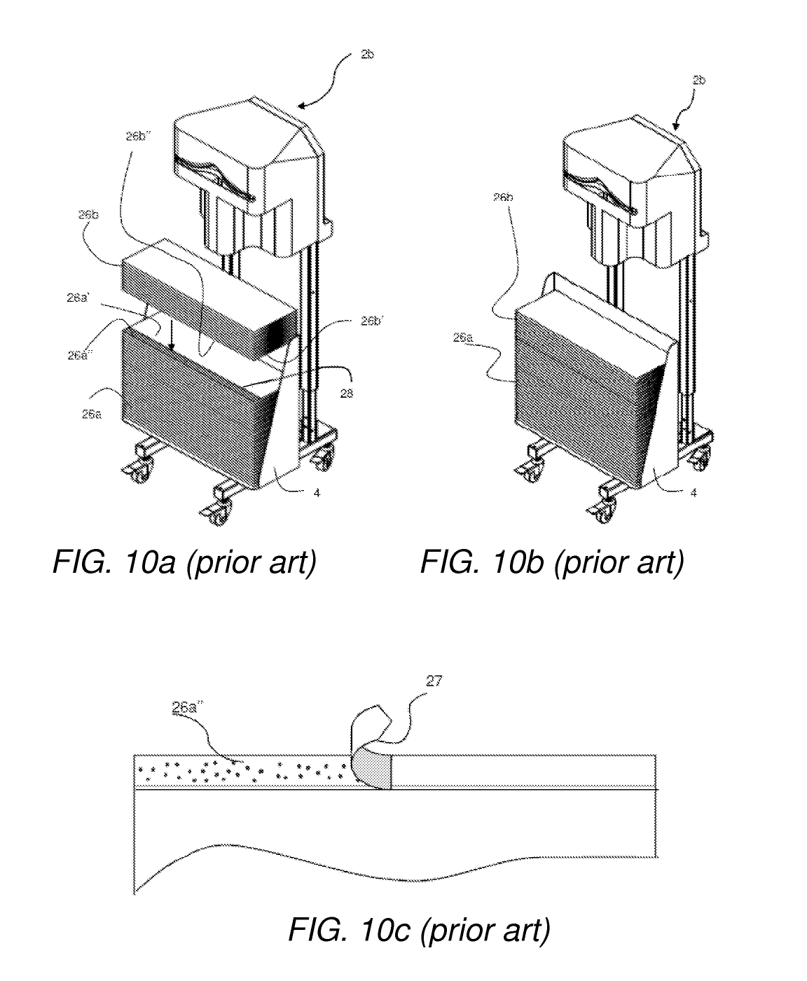

As shown in FIGS. 9a-9b, some embodiments of the present disclosure include a stock material 24a tray 4d having a holding surface 5d which has a cross sectional contour reflecting alternating sloped sections, namely, for example, a first section sloping upward in linear fashion, from left to right, then a second section sloped downward in linear fashion, from left to right, then a third section sloped upward in linear fashion, from left to right, the slopes of each section thus being aligned in zig-zagging fashion. In some embodiments, holding surface 5d is sized to accommodate the fan-fold stack 12c, which can be placed on the holding surface 5d with the longitudinal perforation lines 24′ of the fan-fold stack 12c aligned with intersection edges 5d′ on the holding surface 5d. The intersections edges 5d′ reflect depth-wise extending intersections between the laterally extending alternating slopped sections of the holding surface 5d. Thereafter, as described previously, the fan-fold stack 12c can easily conform to the shape of the holding surface 5d, aided by the weakened perforated lines 24′ which are aligned against the intersection lines 5d′ to allow the sections of fan-fold stack 12c to collapse against the non-planar holding surface 5d at substantially all locations on the holding surface 5d, as best seen in FIG. 9a. In some embodiments, the slopes of the laterally extending sections of the holding surface can be increased or decreased during manufacturing of the holding surface 5d, so that a foot print width of the fan-fold stack as held by the holder 5d can decrease or increase, as will be appreciated by those skilled in the art after reviewing the present disclosure.

In some embodiments of the present disclosure, additional longitudinally extending perforations lines can be provided on the continuous sheet (or multi-ply sheet) of stock material in the fan-fold stack or roll. As will be appreciated by those skilled in the art, although up to two longitudinal perforation lines have been described, three, four, five or more longitudinal perforation lines can be provided. Also, various additional tray configurations can be provided that can be utilized with the perforated stock material. For example, although FIGS. 9a, 9b show three zig-zagging sloped sections for a holding surface, additional zig-zagging slopped sections can be provided, in which intersection edges can be aligned with longitudinal perforation lines on a corresponding fan-fold stack.

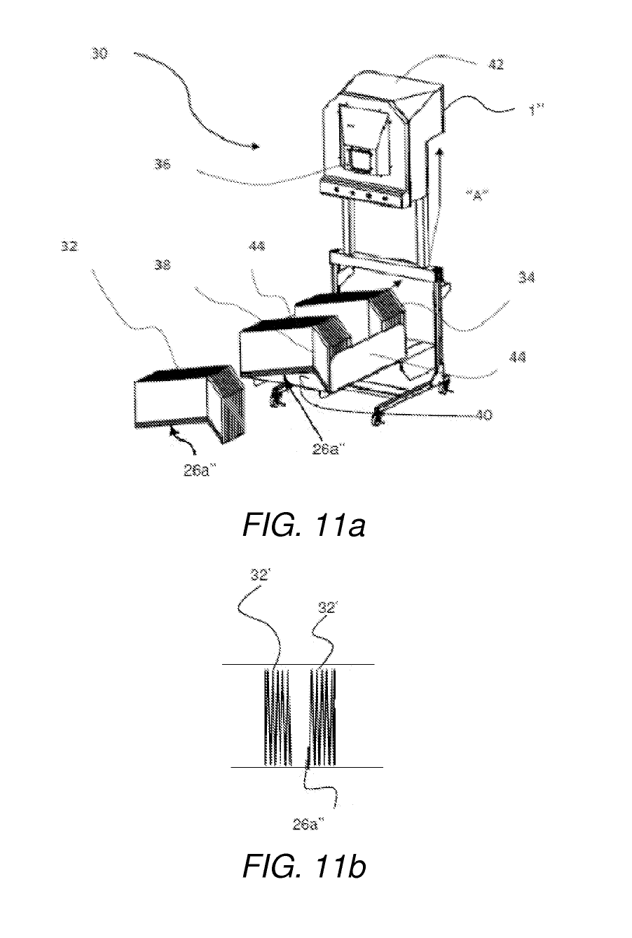

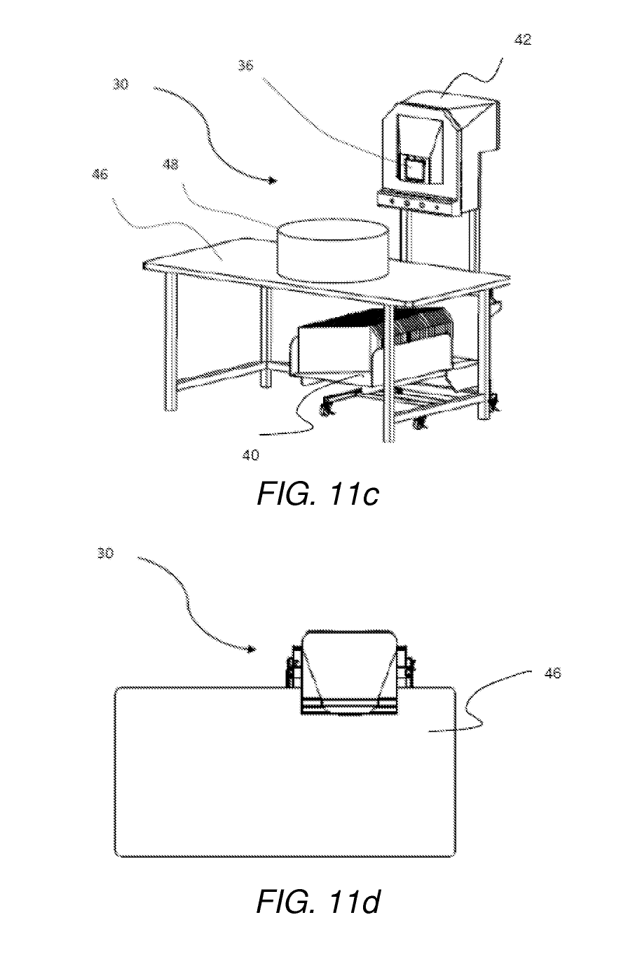

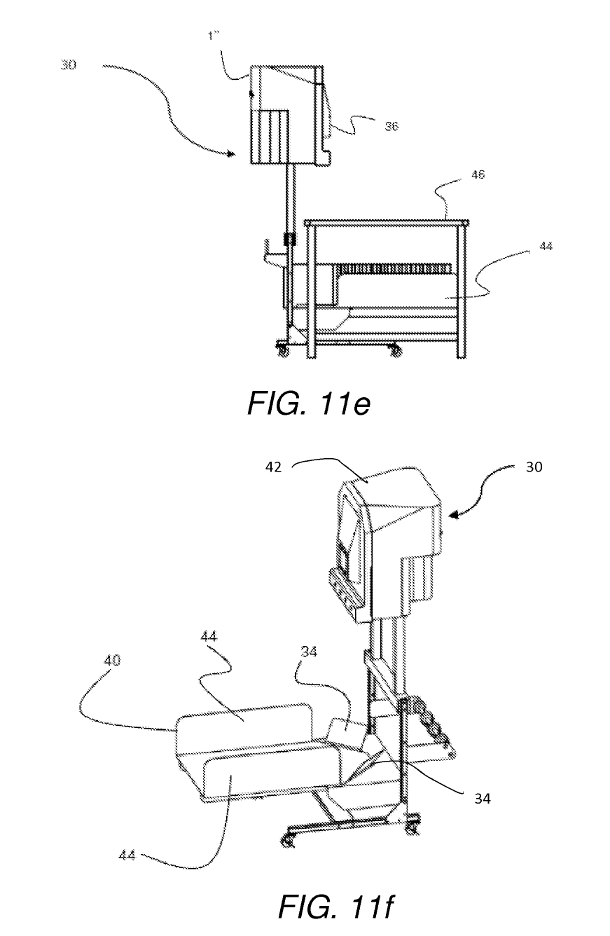

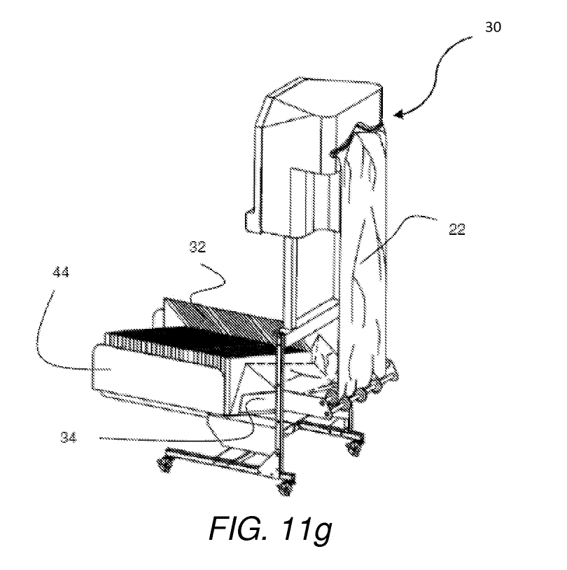

Referring to FIG. 11a, in some embodiments of the present disclosure, a dunnage system 30 is provided in which fan-fold stacks 32 of stock material with centered longitudinal perforation lines 38, can be retained in horizontal fashion (e.g., laying on their sides, as opposed to vertically stacked stock material as described, supra). The fan-fold stacks 32 can be loaded onto a loading tray 40 having bounding sidewalls 44, between which the fan-fold stacks 32 can be placed in horizontal fashion. In some embodiments, a width between the bounding sidewalls 44 dictates a bending angle the user needs to impart between lateral opposing sides of the fan-fold stack 32, on either side of the longitudinal perforation lines 38, to fit the stack horizontally between the sidewalls 44. In some embodiments, when the fan-fold stack is pressed between the sidewalls 44, the tip of an approximate V-shape formed by the fan-fold stack is oriented pointing toward the dunnage system feed 1″, located on a rear side of the dunnage system 30, on an opposite face from the dunnage output port 36. Line “A” in FIG. 11a, with an arrow, represents generally the direction in which stock material is taken up from the horizontally disposed fan-fold stacks 32, into a housing 42 of the dunnage system, within which volumization of the stock material from the fan-fold stacks 32 takes place via motorized forming members, as will be appreciated by those skilled in art after reviewing this disclosure.

Referring to FIGS. 11a, 11f, and 11g, in some alternative embodiments, an end plate 34, or multiple end plates, against which the forwardmost fan-fold stack 32 of the stock material (from which current paper feed is taken), can be pressed up against, with the first sheet in the most forwardmost fan-fold stack 32 pressing against the end plate(s) 34. As will be appreciated by those skilled in the art after reviewing this disclosure, the longitudinal perforation lines 38 that can run the entire continuous sheet in the fan-fold stacks 32 can assist in allowing the fan-fold stacks 32 to press up against, and conform to the end plate(s) 34. Also, in some embodiments, the end plates does not rise vertically the entire depth of the fan-fold stack, so that stock material can be easily taken up along line “A” into a feed on the housing 42. For example, as seen in FIG. 11a, the bounding sidewalls 44 rise only partially the height of the retained fanfold stacks 32, and the end plate 34 could, for example, only rise as high as the bounding sidewalls 44.

FIGS. 11f and 11g also show an alternative configurations for the end plate(s) 34. For example, as best seen in FIG. 11f, a pair of adjacent end plates 34 can be provided, with each being disposed at a lateral angle so that an overhead plan cross section of the plates approximates a v-shape, so that a distance between the end plates decreases extending forward toward a rear side of the housing 42. In some embodiments, the end plates do not join at their forward sections. As the forwardmost fan-fold stack 32 is pressed up against the end plates 34, the relative angels of the end plates 32 helps impart a v-shaped configuration to the fan-fold stacks 32. Also, in some embodiments, the end plates are imparted with a forward slope, and rise to a maximum height that is below a top edge of the bounding sidewalls 44.

In some embodiments, the fan-fold stacks 32 can have more than one longitudinal perforation line, such as, for example, as shown in FIGS. 8 & 10, and as such, when they are disposed in horizontal position, such as shown in FIG. 11a, they can accommodate similar bending configurations described previously, except in a horizontal orientation. Also, an end plate 34 can be configured to match bending configurations to assist a user in pressing the fan-fold stack 32 into bent position.

Referring still to FIG. 11a, as will be appreciated by those skilled in the art after reviewing this disclosure, multiple stacks of fan-fold material can be connected together by connecting the finishing end section of a forward fan-fold stack 32, to a beginning section of a next fan-fold stack 32, such as, for example, by using edges with adhesives 26a″. That is, for example, an adhesive strip 26a″ can run laterally along the edge of a last section of a fan-fold stack, and be used to attach that last section to an adhesive strip running laterally along an edge of a beginning section on a next fan-fold stack. In some embodiments, when a user removes liners 27 (such as those described previously) from the adhesive strips 26a″, and aligns the fan-fold stacks end to end, as shown in FIG. 11a, on the horizontal loading tray 40, then presses them together, the adhesives strips 26′a″ can be caused to adhere to a section on the adjacent fan-fold stack, either to the beginning section of the next fan-fold stack, or to the finishing section of a prior fan-fold stack. As such, when a forward fan-fold stack is depleted, the last section of the forward fan-fold stack will pull from the next fan-fold stack to lead it into the housing of the dunnage machine for volumization, without having to re-prime the dunnage system. In this manner, a user can continue to align new fan-fold stacks on the horizontal loading tray 40 ensuring a constant supply of stock material without having to re-prime the dunnage system for long periods of time.

Referring to FIG. 11b, in some embodiments, a horizontal loading tray for a feed for a dunnage system can receive fan-fold stacks 32′ horizontally, without imparting a bend in the stack (unlike the bend imparted in FIG. 11a). However, an edge of a finishing section, or an edge of a beginning section, of each fan-fold stack 32′, can be lined with an adhesive section, or strip 26a″, for use in a similar manner to that described above. In some embodiments, both the beginning section and finishing section of each fan-fold stack have an edge with an adhesive section 26″, while in other embodiments, only a beginning section, or only a finishing section, of each fan-fold stack has an edge with an adhesive section. Also, a peel away liner can be provided over each of the adhesive sections which can be easily removed before use.

As shown in FIGS. 11c-11e, in some embodiments, the dunnage system 30 permits a user to situate a table top 46 over the loading tray 40 and feed stock for the dunnage system, with the loading tray 40 position lower than the housing 42 of the dunnage system 30, and extending horizontally toward a user position on an output side of the dunnage system 30. In some embodiments, the loading tray extends horizontally forward from a forward side (output side) of the housing 42 at least 8 inches, or at least 12 inches, or at least 24 inches, or at least 30 inches, or at least 36 inches, or at least 42 inches, or at least 48 inches, or more than 48 inches. A user can use the table top 46 to hold work pieces 48 (e.g., containers) which the user can pack with cushioning material (or void fill material) dispensed from the output port 36 of the housing 42. In some embodiments, the horizontally extending loading tray 40 is positioned on the same side of the housing 42 as the output port 36 of the housing 42. This configuration can be ergonomic for the user, who can load the tray 40 from the front of the dunnage system 30, where the user is positioned when packing the container 48 with cushioning materials. Also, since the loading tray 40 can be disposed under the table top, precious space can be conserved on a factory floor.

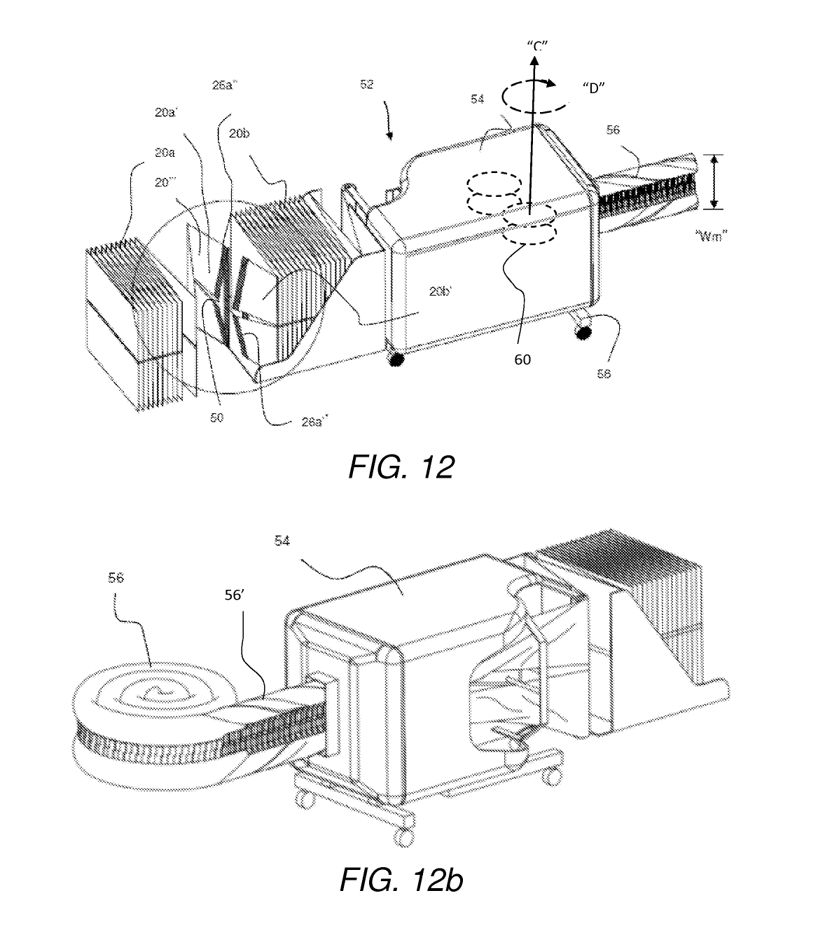

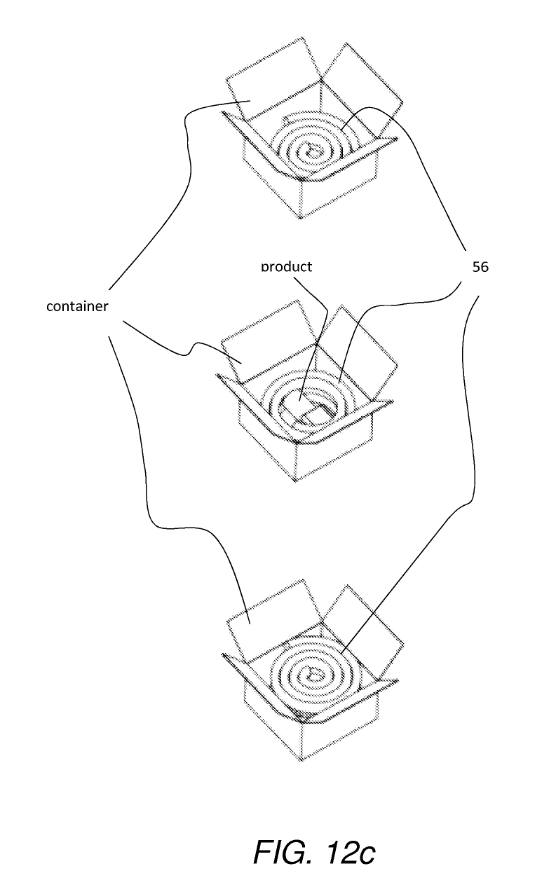

As shown in FIG. 12, in some embodiments, fan-fold stacks 20a, 20b, can be pre-configured. For example (referring also to FIGS. 4a & 4b), a continuous length of perforated stock sheet material, or perforated paper 20, can have outside lateral sections 20′″ that are inwardly folded before formation of the stock material into fan-fold stacks 20a, 20b, (or rolls). Also, the fan-fold stacks 20a, 20b, can be provided with adhesive strip sections 26a″ at an edge of a beginning section (or flap) 20a′ thereof, as shown for stack 20a, and at an edge of a finishing section (or flap) 20b′ thereof, as shown for stack 20b in FIG. 12. In some embodiments, the adhesive strip sections 26a″ are provided on both sides of the paper 20. As such, one of the beginning section 20a′, or finishing section 20b′, can be inserted into a pocket 50 formed between the laterally folded sections 20′″ and a middle unfolded section 20″″ (See, e.g., FIG. 4a) of the other, and an adhesive strip sections 26a″ can contact and bind the beginning section 20a′ and finishing section 20b′ together. In some embodiments, the flap of the beginning section 20a′ and the flap of the beginning section 20b′ are configured so as to extend only partially across the entire depth of the fan-fold stack, whereas all other flaps (fold sections) extend the full depth of the fan-fold stack, as will be appreciated by those skilled in the art after reviewing this disclosure.

Still referring to FIG. 12, in some embodiments of the present disclosure, a housing 54 of the dunnage system 52 can be disposed on its side, in a position that is rotated by approximately 90 degrees about a longitudinal axis thereof, in comparison with a conventional orientation, such as that shown in U.S. Pat. No. 8,501,302. As such, the forming members 60 (e.g., gears) within the housing 54 are also pivoted 90 degrees from conventional orientation. For example, in some embodiments, a gear assembly of a dunnage system 52 that stitches (or otherwise compresses) portions of stock material together, can be disposed with a rotational axis “C” of the gears 60 in vertical orientation such that the gears rotate about the vertical rotational axis “C” in a horizontal direction (plane) as shown by arrow “D,” so that a portion of stock material is stitched/compressed between the gears 60 laterally, to press a vertically extending maximum width “Wm, and can thus also be dispensed as a dunnage strip 56 with a maximum width “Wm” that extends vertically upon output, or otherwise, with a horizontal width that is less than a vertical width (as contrasted with a dunnage strip that is typically dispensed with the maximum width portion extending horizontally, such as shown in U.S. Pat. No. 8,501,302).

A support member 58 for the housing 54 (e.g., legs, wheel, or other resting platform) can be is affixed or positioned on the housing 54 so that when the housing is set down against a resting surface on the support member 58, the housing is axially off-set from its conventional orientation by 90 degrees. This upright side edge 56′ orientation of the dunnage strip 56, with the maximum width “Wm” being oriented vertically, can provide distinct advantages in packaging. In particular, a user can easily bend the dunnage strip horizontally to wind the dunnage strip to form a cushioning surface that can be disposed in a container for protecting product in the container (See, e.g., FIGS. 12b, 12c). Alternatively, a user can wind the dunnage horizontally about a product before placing it in a container, or placing a wound dunnage strip in the container below a product, or above a product (See, e.g., FIG. 12c).

After reviewing the present disclosure, an individual of ordinary skill in the art will immediately appreciate that some details and features can be added, removed and/or changed without deviating from the spirit of the invention. Reference throughout this specification to “one embodiment,” “an embodiment,” “additional embodiment(s)” or “some embodiments,” means that a particular feature, structure or characteristic described in connection with the embodiment(s) is included in at least one or some embodiment(s), but not necessarily all embodiments, such that the references do not necessarily refer to the same embodiment (s). Furthermore, the particular features, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A continuous stock material provided in a roll or a fan-fold stack configuration for use in feeding a dunnage machine, the stock material having at least one longitudinal perforation line.

2. The continuous stock material of claim 1 wherein the longitudinal perforation line extends continuously throughout an entire length of the continuous stock material in the roll or fan-fold stack.

3. The continuous stock material of claim 1 further at least a second longitudinal perforation line.

4. The continuous stock material of claim 3 further comprising a plurality of lateral perforation lines.

5. The continuous stock material of claim 1 further comprising at least one laterally centrally disposed longitudinal perforation line, and one longitudinal perforation line disposed parallel to the centrally disposed longitudinal perforation line on each side of the centrally disposed longitudinal perforation line.

6. A dunnage system comprising:
a housing containing a forming member;
a motor for driving the forming member; and
a stock material loading tray, the loading tray having a planar holding surface configured to retain multiple stacks of fan folded stock material placed horizontally on the holding surface.

7. The dunnage system of claim 6 further comprising a first fan-fold stack of stock material and a second fan-fold stack of stock material, with both fan-fold stacks of stock material retained in horizontal orientation on the loading tray and with the first fan-fold stack of stock material attached by a finishing section thereof to a beginning section of the second fan-fold stack of stock material.

8. The dunnage system of claim 6 wherein the housing has an output port disposed on a front portion of the housing, and the loading tray is disposed below the housing and extends forward from the front portion of the housing by at least 8 inches during operation of the dunnage system.

9. The dunnage system of claim 8 wherein the loading tray comprises an end plate imparted with a lateral angle.

10. The dunnage system of claim 9 wherein stock material is fed from the holding tray upward to the inlet port.

11. The dunnage system of claim 10 further comprising a work surface positioned above the loading tray.

12. A dunnage system comprising:
a housing having a feed port and an output port;
a forming member contained within the housing;
a motor for driving the forming member; and
a stock material feed tray having a holding surface with varying slope.

13. The dunnage system of claim 12 wherein the holding surface is curved.

14. The dunnage system of claim 12 wherein at least a portion of the holding surface slopes laterally inwardly upward, from opposing lateral sides of the holding surface.

15. The dunnage system of claim 12 wherein at least a portion of the holding surface slopes laterally inwardly downward from opposing lateral sides of the holding surface.

16. The dunnage system of claim 12 wherein at least a first portion of the holding surface is planar and has a first linear slope.

17. The dunnage system of claim 16 wherein at least a second portion of the holding surface is planar and has a second linear slope that is different from the first linear slope.

18. The dunnage system of claim 17 wherein the first portion of the holding surface and the second portion of the holding surface intersect such that a cross sectional contour of the holding surface approximates the shape of a “V.”

19. The dunnage system of claim 17 wherein the first portion of the holding surface the second portion of the holding surface intersect such that a cross sectional contour of the holding surface approximates a shape of an inverted “V.”

20. The dunnage system of claim 17 wherein at least a third portion of the holding surface is planar and has a third linear slope that is different from at least the first linear slope or the second linear slope.

21. The dunnage system of claim 20 wherein at least a fourth portion of the holding surface is planar and has a fourth linear slope.

22. The dunnage system of claim 17 wherein an angle between a paper holding surface of the first portion of the holding surface, and a paper holding portion of the second portion of the holding surface is less than or equal to 120 degrees.

23. The dunnage system of claim 17 wherein an angle between a paper holding surface of the first portion of the holding surface, and a paper holding portion of the second portion of the holding surface is less than or equal to 105 degrees.

24. The dunnage system of claim 9 wherein an angle between a paper holding surface of the first portion of the holding surface, and a paper holding portion of the second portion of the holding surface is less than or equal to 90 degrees.

25. A continuous pre-configured stock material configured in rolled or fan-fold form for use in feeding a dunnage machine, the pre-configured stock material comprising:
a longitudinal perforation line extending a full longitudinal length of the continuous pre-configured stock material; and
a laterally inwardly folded longitudinally extending section extending a full longitudinal length of the continuous pre-configured stock material.

26. The pre-configured stock material of claim 25 further comprising at least a second longitudinal perforation line.

27. The pre-configured stock material of claim 25 further comprising at least one laterally extending perforation line.

28. The pre-configured stock material of claim 27 further comprising at least a second laterally extending perforation line.

29. The pre-configured stock material of claim 25 further comprising a second laterally inwardly folded longitudinally extending section extending a full longitudinal length of the continuous pre-configured stock material.

30. The pre-configured stock material of claim 29 further comprising at least one laterally extending perforation line.

31. A method of generating a pre-configured stock material comprising:
imparting a longitudinal perforation line extending a full length of a continuous stock material;
folding a longitudinally extending section of the stock material laterally across at least a portion of the width of the stock material; and
winding the stock material in a roll or fan-folding the stock material.

32. The method of claim 31 further comprising imparting at least a second longitudinal perforation line in the stock material, wherein the second longitudinal perforation line is laterally centrally disposed.

33. The method of claim 32 further comprising imparting a lateral perforation line extending a full width of the stock material.

34. The method of claim 33 further comprising imparting at least four longitudinal perforation lines.

35. A method of loading a dunnage machine comprising:
feeding a first fan-fold stack of stock material to a dunnage machine, the fan-fold stack being retained in horizontal orientation during feeding to the dunnage machine; and
attaching a section of a second fan-fold stack of stock material to a section of the first fan-fold stack and retaining the second fan-fold stack in a horizontal orientation during feeding to the dunnage machine.

36. The method of claim 35 wherein attaching a section of the second fan-fold stack to a section of the first fan-fold stack comprises using an adhesive to bind the sections together.

37. The method of claim 35 further comprising imparting a lateral bend to the first or second fan-fold stacks while retaining the first or second fan-fold stacks in a horizontal orientation.

38. The method of claim 37 wherein the lateral bend is imparted, in part, by pressing the first or second fan-fold stack against one or more end plates having a non-linear cumulative contour.

39. A dunnage system comprising:
a housing;
a forming member within the housing, the housing having a stock material input side and a dunnage output side; and
a feed source of stock material with at least a portion of the feed source retained proximate the dunnage output side and extending horizontally forward therefrom in an opposite direction from the stock material input side, wherein the feed source is a fan-fold stack of stock material and wherein the fan-fold stack is retained in a horizontal orientation.

40. The dunnage system of claim 39 wherein a second fan-fold stack of stock material is connected to the fan-fold stack of stock material, with at least a portion of the second fan-fold stack being positioned proximate the dunnage output side, opposite the stock material input side.

41. The dunnage system of claim 40 wherein the second fan-fold stack of stock material is retained in a horizontal orientation.

42. The dunnage system of claim 41 wherein a work surface is disposed above at least a portion of the fan-fold stack.

43. The dunnage system of claim 42 wherein the work surface is a table top.

44. A dunnage system comprising:
a housing containing one or more forming members;
a motor connected to the forming members; and
wherein the housing is resting on a horizontal surface and is oriented to dispense cushioning material in a continuous dunnage strip having a vertical width that is greater than a horizontal width.

45. The dunnage system of claim 44 wherein the dunnage strip has a maximum width that is substantially vertically oriented.

45. The dunnage system of claim 44 wherein the forming members are oriented to rotate about a vertical axis.

46. A method of protecting a work piece using cushioning material comprising:
disposing a housing of a dunnage machine containing a plurality of forming members in a resting position wherein the forming members rotate about a vertical axis; and
operating a motor of the dunnage machine to compress stock material between the forming members to dispense a continuous strip of cushioning material.

47. The method of claim 46 wherein the continuous strip is dispensed from the housing in an orientation wherein a maximum lateral width of the continuous strip is substantially vertically disposed.

48. The method of claim 46 further comprising bending the dispensed continuous strip horizontally to wind the continuous strip, before cutting a dispensed section of the continuous strip near an outlet port of the housing to release it from the dunnage machine.

49. The method of claim 48 further comprising disposing the wound dispensed section about a product to be packaged.

50. The method of claim 48 further comprising disposing the wound dispensed section within a container below a product to be packaged.

51. The method of claim 48 further comprising disposing the wound dispensed section within a container above a product to be packaged.
